(19) United States
(12) Patent Application Publication
(10) Pub. No.: US 2008/0270310 A1
(43) Pub. Date: Oct. 30, 2008

(54) FACILITATING DYNAMIC CONFIGURATION OF SOFTWARE PRODUCTS

(75) Inventors: David B. DeGraaff, Mountain View, CA (US); Andrew A. Woods, Mountain View, CA (US); Alvin Hsung-Un Lee, Redwood City, CA (US); Stephen L. Molloy, Andover, MA (US); Michael A. Meagher, Cary, NC (US); Hunter D. Smith, El Cajon, CA (US); Richard W. Cook, Tucson, AZ (US); Gaurav Kotak, San Francisco, CA (US); Lisa E. Woods, Knoxville, TN (US)

Correspondence Address: PVF -- INTUIT, INC.;c/o PARK, VAUGHAN & FLEMING LLP, 2820 FIFTH STREET, DAVIS, CA, 95618-7759, US

(73) Assignee: INTUIT INC., Mountain View, CA (US)

(21) Appl. No.: 11/829,430

(22) Filed: Jul. 27, 2007

Related U.S. Application Data
(63) Continuation-in-part of application No. 11/476,990, filed on Jun. 27, 2006.

(51) Int. Cl. H04L 9/00

(52) U.S. Cl. 705/58

(57) ABSTRACT

Embodiments of a system that provides access to at least a portion of a software product are described. During operation, this system receives purchase information from a first location, where the purchase information includes information about purchased software features to which a user purchased access and where the purchased software features are provided by a first subset of modules in the software product. Next, the system receives an access request from a second location from which the software product can be accessed, where the access request includes an identifier provided to the user when the user purchased access to the purchased software features. Next, the system provides configuration instructions to the second location, where the configuration instructions dynamically enable the first subset of the modules.

### CROSS REFERENCE TO RELATED APPLICATIONS

This application is a continuation-in-part of pending U.S. patent application Ser. No. 11/476,990, filed on Jun. 27, 2006 by inventors Edmund Y. L. Sung, Timothy A. Rosemore, Jennifer Possin, Raymond S. Tenenbaum, and Stephen L. Molloy, entitled, “Method and Apparatus for Authorizing a Software Product to be Used on a Computer System” (Attorney Docket No. INTU-060798), the contents of which are herein incorporated by reference. This application hereby claims priority under 35 U.S.C. §120 to the above-listed parent patent application.

### BACKGROUND

The present invention relates to techniques for dynamically configuring software products. More specifically, the present invention relates to a system that facilitates dynamic configuring of software products.

While there has been considerable recent growth in on-line commerce, physical retail establishments remain an important sales channel. Unfortunately, these physical retail establishments have inherent operating costs that can limit profit margins. For example, many retail establishments carry a diverse range of products and maintain large inventories to satisfy the needs of different customers. However, the diverse range of products and the large inventories increase the expense involved in running a retail establishment, for example, by requiring more display space.

These problems also affect software products. In particular, many software vendors provide a range of closely related software products in a product family that have different features and price points, such as consumer and professional versions of tax-preparation software. Typically, the software products in these product families share multiple modules. Consequently, when changes to a given module are required, these changes can impact multiple software products, with associated effects on testing and distribution.

Retail establishments typically carry and display the various software products in a given product family, which places demands on valuable shelf or floor space, thereby increasing the size of the retail establishments and significantly increasing inventory requirements. Unfortunately, it is often difficult to properly manage inventory for such a broad range of software products. Consequently, retail establishments may have too little inventory for popular software products and too much inventory for less-popular software products.

Moreover, companies typically bundle a discrete set of features into each of these software products in an attempt to meet the needs of a specific group of customers and to differentiate the software products from one another. However, customers often purchase a given software product based on a small subset of these features, and the remaining features have little or no incremental value to the customer. Moreover, these additional features often increase the complexity of user interfaces in the given software product and may therefore degrade the overall user experience for the software product.

Therefore, the sale of software products through retail establishments is often complicated by the need to provide a wide range of software products having different sets of fixed features.

### SUMMARY

One embodiment of this invention relates to a system that provides access to at least a portion of a software product. During operation, this system receives purchase information from a first location, where the purchase information includes information about purchased software features to which a user purchased access and where the purchased software features are provided by a first subset of modules in the software product. Next, the system receives an access request from a second location, where the access request includes an identifier provided to the user when the user purchased access to the purchased software features. Next, the system provides configuration instructions to the second location from which the software product can be accessed, where the configuration instructions dynamically enable the first subset of the modules.

In some embodiments, the configuration instructions include a decryption key. For example, the decryption key may include a public key associated with a private key that was used to encrypt at least a portion of the software product.

In some embodiments, dynamically enabling the first subset of modules allows the user to use the purchased software features: without reinstalling a portion of the software product; without first rebooting a computer on which the software product is installed; and/or without installing another portion of the software product. Moreover, in some embodiments dynamically enabling the first subset of modules allows the user to use the purchased software features without downloading additional modules.

In some embodiments, the first subset of modules is dynamically enabled while the software product is executing on a computer.

In some embodiments, the configuration instructions facilitate ‘a la carte’ selection of the purchased software features by the user from modules which are already tested and compiled in the software product.

In some embodiments, the first location is a physical retail establishment and/or an online retail establishment. Moreover, the first location may be different from the second location.

In some embodiments, the configuration instructions are provided by a server to the second location via a network.

In some embodiments, the operations of receiving the access request and providing the configuration instructions are repeated after a time interval, thereby allowing synchronization of current software features that are enabled in the software product.

In some embodiments, the system receives a purchase request and payment from the user, where the purchase request includes information associated with additionally purchased software features, and where the additionally purchased software features are associated with a second subset of modules in the software product. Next, the system provides additional configuration instructions to the second location, where the additional configuration instructions dynamically enable the second subset of the modules. Note that the additionally purchased features may be different than the purchased features or the additionally purchased features may at least partially overlap the purchased features. Moreover, in some embodiments the payment is based on the additionally purchased software features.

Another embodiment relates to a computer program product for use in conjunction with the system. This computer program product may include instructions corresponding to at least some of the above-described operations.

Another embodiment provides a method for providing access to at least a portion of the software product. This method may perform at least some of the above-described operations.

### BRIEF DESCRIPTION OF THE FIGURES

FIG. 1 is a block diagram illustrating a computer system including computers and servers that are networked together in accordance with an embodiment of the present invention.

FIG. 2 is a flow chart illustrating a method for providing access to at least a portion of the software product in accordance with an embodiment of the present invention.

FIG. 3 is a block diagram illustrating a computer system in accordance with an embodiment of the present invention.

FIG. 4 is a block diagram illustrating a data structure in accordance with an embodiment of the present invention.

FIG. 5 is a block diagram illustrating a data structure in accordance with an embodiment of the present invention.

Note that like reference numerals refer to corresponding parts throughout the drawings.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

Embodiments of a computer system, a method, and a computer program product (i.e., software) for use with the computer system are described. These systems, software, and processes may be used to provide access to at least a portion of a software product. In particular, the computer system may provide configuration instructions to a user who has previously purchased access to software features. These configuration instructions may dynamically enable use of a subset of modules in a software product that are associated with the purchased software features. Note that the access to the software features may be purchased in a physical retail establishment and/or in an online retail establishment, such as at a website or a web page.

In some embodiments, the configuration instructions facilitate ‘a la carte’ selection of the purchased software features by the user from modules which are already tested and compiled in the software product. Moreover, the user may dynamically enable the subset of modules: without reinstalling a portion of the software product; without first rebooting a computer on which the software product is installed; and/or without installing another portion of the software product.

At a later time, the user may purchase additional software features from the computer system, and the computer system may provide additional configuration instructions that dynamically enable an additional subset of modules in the software product that are associated with the additional software features. Note that the additional modules may be different than or at least partially overlap the subset of modules, and that payment may be based on the additionally purchased software features.

These techniques may be implemented as a stand-alone software application, or as a program module or subroutine in another application. Furthermore, at least a portion of the program may be configured to execute on a client computer (such as a personal computer, a laptop computer, cell phone, PDA, or other device capable of manipulating computer readable data) or remotely from a client computer via associated computing systems over a network (such as the Internet, Intranet, LAN, WAN, MAN, or combination of networks, or other technology enabling communication between computing systems). Therefore, the purchase information, the software product, and the configuration instructions may be stored locally (for example, on a local computer) and/or remotely (for example, on a computer or server that is accessed via a network).

By dynamically enabling subsets of modules and/or subsets of features in a previously tested and complied software product, these techniques allows software features in this software product to be customized to the needs of a given user. In turn, this capability allows retail establishments to carry and display fewer software products, thereby simplifying operations, reducing expenses, and/or reducing shortfalls or excesses in inventory. Moreover, such software products are generally less complex, and easier to test and distribute. For example, by allowing the user to only purchase those features that are of interest, the user interface can be simplified and overall user experience can be improved.

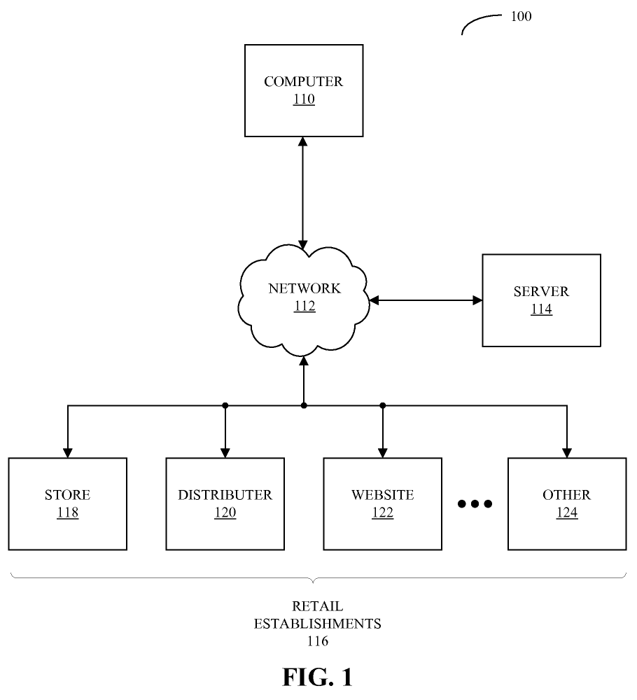

We now describe embodiments of systems, devices, and processes for providing access to at least a portion of a software product. FIG. 1 presents a block diagram illustrating an embodiment of a computer system 100 including computers and servers that are networked together. In this embodiment, a user may first purchase a software product or access to at least a portion of the software product from one or more retail establishments 116, which can include: a store 118, a distributor 120, a website 122, and/or another 124 sales channel. In general, the software product or at least the portion of the software product includes one or more software features that the user would like to use. Moreover, these software features are associated with at least a subset of the modules in the software product.

When the user purchases the software product or purchases access to a portion of the software product, the user receives a token or an identifier, which corresponds to the user's purchase. Moreover, the user may receive instructions on how to use the identifier to receive the software product, or to enable access to the portion of the software product. For example, the user may purchase an encrypted version of the software product, and (as described below) the user may follow the instructions and use the identifier to enable access to at least the portion of the software product. Alternatively, the user may follow the instructions and use the identifier to receive at least the portion of the software product or to access the software feature(s) associated with at least the portion of the software product.

After the purchase transaction is complete, the retail establishment (such as the store 118) may provide purchase information to a server 114 via a network 112, such as the Internet. This server may be associated with a provider of the software product, and the purchase information may include the identifier provided to the user, and information about the software product or a portion of the software product that the user has paid to access. More generally, the purchase information includes information about purchased software features to which the user has purchased access.

Then, the user may access the server 114 from a computer 110 through network 112. Computer 110 may be remotely located from the retail establishments 116. For example, computer 110 may be at the user's home or work location. When the user accesses server 114, the user may provide an access request, which includes the identifier.

Based on the purchase information and the access request, the server 114 may enable the user to access the subset of the modules and/or the subset of the features in the software product (which may be associated with the subset of the software modules). In some embodiments, the server 114 may provide configuration instructions to the computer 110. These configuration instructions may dynamically enable the subset of the modules and/or the subset of the features. For example, the configuration instructions may include a decryption key, such as a public key associated with a private key that was used to previously encrypt at least the portion of the software product. Using this decryption key, the user may decrypt at least the portion of the software product that was purchased from one of the retail establishments 116.

In an exemplary embodiment, the user installs the purchased software product on the computer 110. This software product may include multiple modules (associated with different software features). Moreover, the multiple modules may already be compiled and tested, and are hence ready for use. However, these modules may be encrypted, so that the user first needs to decrypt a given module prior to using the module. By accessing and receiving the configuration instructions (including one or more decryption keys), the user may decrypt and use the appropriate subset of the modules that the user has paid to access.

Note that in these embodiments the software product sold by the retail establishments 116 may include more modules and/or more software features than the typical user may want to access at a given time. Rather than stocking and selling different versions of this software product, retail establishments 116 can stock a generic version of the software product. Moreover, retail establishments 116 can tailor this generic software product to the needs a specific user by allowing the user to select, ‘a la carte,’ those software features that the user would like to access. As described above, computer system 100 allows the users to subsequently receive the appropriate configuration instructions to dynamically enable the subset of the modules and/or the subset of the software features that are purchased.

The dynamic enablement of the subset of the modules and/or the subset of the software features in the software product may be performed without the user: reinstalling a portion of the software product; without first rebooting the computer 110 on which the software product is installed; and/or without installing another portion of the software product. Moreover, in some embodiments dynamically enabling the subset of modules and/or the subset of the software features allows the user to use the purchased software features without downloading additional modules. Consequently, the subset of modules and/or the subset of the software features may be dynamically enabled while the software product is executing on the computer 110.

In some embodiments, after a time interval, the user repeats the operation of providing the access request to the server 114, and the server 114 repeats the operation of providing the configuration instructions. For example, a version of the configuration instructions may expire after the time interval, and a newer version may be needed. This may allow synchronization of current software features that are enabled in the software product or may allow access to the software features to be sold on a subscription basis. Thus, the user may routinely or periodically pay to continue access to the subset of the modules and/or the subset of the software features.

Moreover, after the initial purchase, the user may choose to purchase access to an additional subset of the modules and/or additional subset of the software features in the software product. In these embodiments, the user may purchase access to the additional software features from one of the retail establishments 116 or directly from the provider of the software product (for example, via the server 114). After receiving a purchase request (including information associated with additional software features) and payment from the user (which may be based on the additional software features), server 114 may provide additional configuration instructions that dynamically enable the additional subset of the modules and/or the additional subset of the software features to the computer 110. Note that these additional software features: may include the original software features purchased by the user, may partially overlap the original software features, or may be different software features. Furthermore, the additional subset of the modules: may include the subset of the modules, may partially overlap the subset of modules, or may include different modules.

In other embodiments, the user does not receive the software product from one of the retail establishments 116 at the time of purchase. For example, the user may subsequently download the software product from the server 114 onto computer 110. Note that the software product may be a stand-alone application on the computer 110 and/or may be embedded in another application. In an exemplary embodiment, the software product includes income-tax preparation software and/or financial-accounting software.

In some embodiments, the income-tax software includes: TurboTax™ (from Intuit, Inc., of Mountain View, Calif.), TaxCut™ (from H&R Block, Inc., of Kansas City, Mo.), TaxAct™ (from 2^{nd} Story Software, Inc., of Cedar Rapids, Iowa), and/or other software capable of preparing an income-tax return. Furthermore, in some embodiments the financial-accounting software includes payroll-accounting software, such as QuickBooks™ (from Intuit, Inc., of Mountain View, Calif.), PeachTree Complete™ (from the Sage Group PLC, of London, the United Kingdom), MYOB Business Essentials™ (from MYOB US, Inc., of Rockaway, N.J.), NetSuite Small Business Accounting™ (from NetSuite, Inc., of San Mateo, Calif.), Cougar Mountain™ (from Cougar Mountain Software, of Boise, Id.), Small Business Manager™ (from Microsoft Corporation, of Redmont, Wash.), Simply Accounting™ (from the Sage Group PLC, of London, the United Kingdom), CYMA IV Accounting™ (from CYMA Systems, Inc., of Temple, Ariz.), DacEasy™ (from Sage Software SB, Inc., of Lawrenceville, Ga.), Microsoft Money™ (from Microsoft Corporation, of Redmont, Wash.), and/or other financial-accounting software capable of processing payroll information. Finally, in some embodiments the financial-accounting software includes financial-planning software, such as Quicken™ (from Intuit, Inc., of Mountain View, Calif.), Microsoft Money™ (from Microsoft Corporation, of Redmont, Wash.), SplashMoney™ (from SplashData, Inc., Los Gatos, Calif.), Mvelopes™ (from In2M, Inc., Draper, Utah), and/or open-source applications such as Gnucash™, PLCash™, Budget™ (from Snowmint Creative Solutions, LLC), and/or other financial-planning software capable of processing financial information.

While the software product may be resident on the computer 110, other embodiments may utilize a software tool that is embedded in a web page (once again, either as a stand-alone application or as a portion of another application). This web page may be provided by a server 114 via network 112. In an exemplary embodiment, the financial-software tool is a software package written in JavaScript™ (i.e., the financial-software tool includes programs or procedures containing JavaScript instructions), ECMAScript (the specification for which is published by the European Computer Manufacturers Association International), VBScript™ (a trademark of Microsoft, Inc.) or any other client or server-side scripting language. In other words, the software tool may include programs or procedures containing JavaScript, ECMAScript instructions, VBScript instructions, or instructions in another programming language suitable for rendering by a browser or another client application on the computer 110. In these embodiments, configuration instructions provided with the web page or previously provided to the computer 110 may be used to dynamically enable access to the software tool.

In an exemplary embodiment, a software product sold by the retail establishments includes modules and/or features associated with three software product types (such as consumer, advanced, and professional), each of which includes five groups of software features. Based on the user selections, the software product may be configured to the needs of a given user. For example, the configuration instructions may select one of the software product types and one of four different arrangements of the five groups of software features.

In some embodiments the computer system 100 includes fewer or additional components. Moreover, two or more components can be combined into a single component, and/or a position of one or more components may be changed.

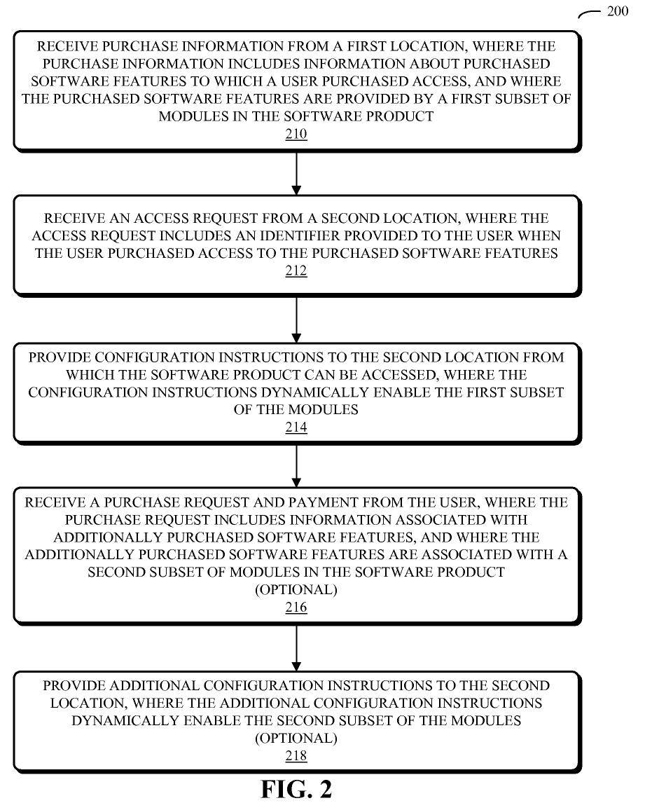

We now discuss methods for providing access to software products. More specifically, FIG. 2 presents a flow chart illustrating an embodiment of a method 200 for providing access to at least a portion of the software product, which may be implemented in a computer system, such as the computer system 100 in FIG. 1. During operation, this system receives purchase information from a first location (210), where the purchase information includes information about purchased software features to which a user purchased access and where the purchased software features are provided by a first subset of modules in the software product. Next, the system receives an access request from a second location from which the software product can be accessed (212), where the access request includes an identifier provided to the user when the user purchased access to the purchased software features. Then, the system provides configuration instructions to the second location (214), where the configuration instructions dynamically enable the first subset of the modules.

In some embodiments, the system optionally receives a purchase request and payment from the user (216), where the purchase request includes information associated with additionally purchased software features and where the additionally purchased software features are associated with a second subset of modules in the software product. Next, the system optionally provides additional configuration instructions to the second location (218), where the additional configuration instructions dynamically enable the second subset of the modules.

Note that in some embodiments of the method 200 there may be: additional or fewer operations; the order of the operations may be changed; and two or more operations may be combined into a single operation.

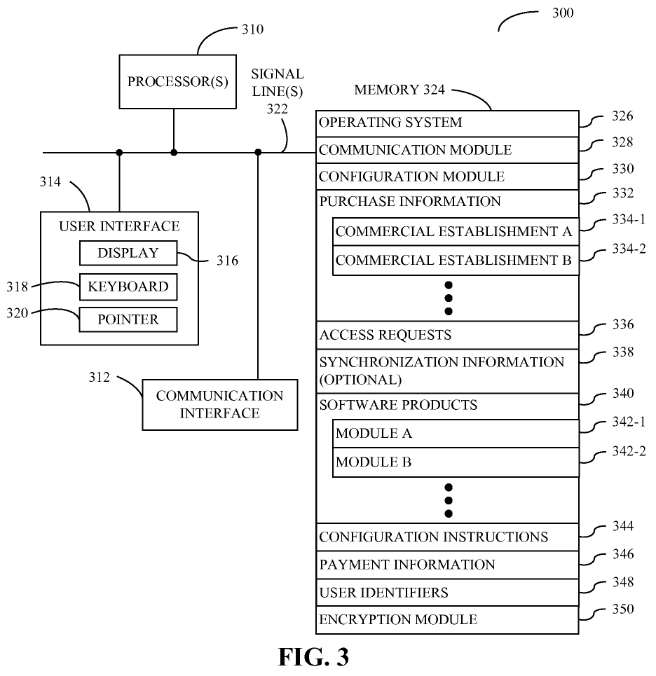

We now describe computer systems for implementing these techniques. FIG. 3 presents a block diagram illustrating an embodiment of a computer system 300. Computer system 300 includes: one or more processors 310, a communication interface 312, a user interface 314, and one or more signal lines 322 coupling these components together. Note that the one or more processing units 310 may support parallel processing and/or multi-threaded operation, the communication interface 312 may have a persistent communication connection, and the one or more signal lines 322 may constitute a communication bus. Moreover, the user interface 314 may include: a display 316, a keyboard 318, and/or a pointer 320, such as a mouse.

Memory 324 in the computer system 300 may include volatile memory and/or non-volatile memory. More specifically, memory 324 may include: ROM, RAM, EPROM, EEPROM, FLASH, one or more smart cards, one or more magnetic disc storage devices, and/or one or more optical storage devices. Memory 324 may store an operating system 326 that includes procedures (or a set of instructions) for handling various basic system services for performing hardware dependent tasks. While not shown in the computer system 100, in some embodiments memory 324 includes a browser. Memory 324 may also store communication procedures (or a set of instructions) in a communication module 328. These communication procedures may be used for communicating with one or more computers and/or servers, including computers and/or servers that are remotely located with respect to the computer system 300.

Memory 324 may include multiple program modules (or a set of instructions), including configuration module 330 (or a set of instructions) and/or encryption module 350 (or a set of instructions). Configuration module 330 may use purchase information 332 (such as that associated with commercial establishment A 334-1 and/or commercial establishment B 334-2) to provide configuration instructions 344 in response to one or more access requests 336. Moreover, in some embodiments one or more user identifiers 348 and/or payment information 346 are provided along with the one or more access requests 336. These configuration instructions 344 may dynamically enable at least a subset of the modules and/or a subset of the software features in software products 340 (such as module A 342-1 and/or module B 342-2).

In some embodiments, the configuration instructions 344 include one or more decryption keys associated with encryption module 350. For example, encryption module 350 may encrypt the software products 340, and the decryption keys may be used to decrypt one or more of the modules 342.

Moreover, in some embodiments the configuration module 330 is used to routinely or periodically synchronize the enabled modules and/or enabled features in the software products 340 using optional synchronization information 338.

Instructions in the various modules in the memory 324 may be implemented in a high-level procedural language, an object-oriented programming language, and/or in an assembly or machine language. The programming language may be compiled or interpreted, i.e., configurable or configured to be executed by the one or more processing units 310.

Although the computer system 300 is illustrated as having a number of discrete components, FIG. 3 is intended to provide a functional description of the various features that may be present in the computer system 300 rather than as a structural schematic of the embodiments described herein. In practice, and as recognized by those of ordinary skill in the art, the functions of the computer system 300 may be distributed over a large number of servers or computers, with various groups of the servers or computers performing particular subsets of the functions. In some embodiments, some or all of the functionality of the computer system 300 may be implemented in one or more ASICs and/or one or more digital signal processors DSPs.

Computer system 300 may include fewer components or additional components. Moreover, two or more components may be combined into a single component and/or a position of one or more components may be changed. In some embodiments the functionality of the computer system 300 may be implemented more in hardware and less in software, or less in hardware and more in software, as is known in the art.

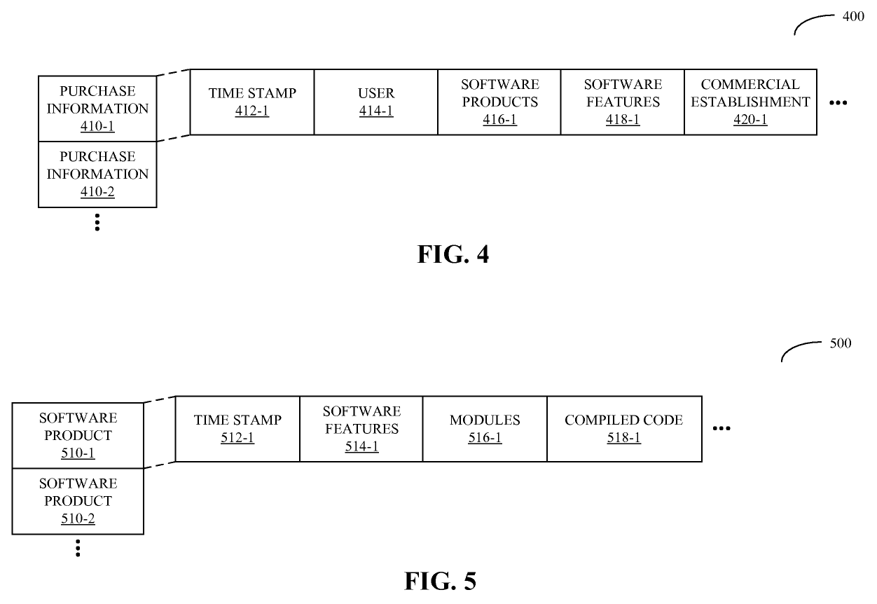

We now describe data structures that may be used in the computer system 100 (FIG. 1) and/or 300 (FIG. 3). FIG. 4 presents a block diagram illustrating an embodiment of a data structure 400. This data structure may include purchase information 410. Given purchase information 410, such as purchase information 410-1, may include: a time stamp 412-1, a user 414-1, one or more software products 416-1, one or more software features 418-1, and/or one or more commercial establishments 420-1.

FIG. 5 presents a block diagram illustrating an embodiment of a data structure 500. This data structure may include information associated with software products 5 10. Information for a given software product, such as software product 510-1, may include: a time stamp 512-1, one or more software features 514-1, one or more modules 516-1, and/or compiled code 518-1.

Note that that in some embodiments of the data structures 400 (FIG. 4) and/or 500 there may be fewer or additional components. Moreover, two or more components may be combined into a single component, and/or a position of one or more components is changed.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for providing access to at least a portion of a software product, comprising:
receiving purchase information from a first location, wherein the purchase information includes information about purchased software features to which a user purchased access, and wherein the purchased software features are provided by a first subset of modules in the software product;
receiving an access request from a second location from which the software product can be accessed, wherein the access request includes an identifier provided to the user when the user purchased access to the purchased software features; and
providing configuration instructions to the second location, wherein the configuration instructions dynamically enable the first subset of the modules.

2. The method of claim 1, wherein the configuration instructions include a decryption key.

3. The method of claim 2, wherein the decryption key includes a public key associated with a private key that was used to encrypt at least another portion of the software product.

4. The method of claim 1, wherein dynamically enabling the first subset of modules allows the user to use the purchased software features without reinstalling a portion of the software product.

5. The method of claim 1, wherein dynamically enabling the first subset of modules allows the user to use the purchased software features without first rebooting a computer on which the software product is installed.

6. The method of claim 1, wherein dynamically enabling the first subset of modules allows the user to use the purchased software features without installing a portion of the software product.

7. The method of claim 1, wherein dynamically enabling the first subset of modules allows the user to use the purchased software features without downloading additional modules.

8. The method of claim 1, wherein the first subset of modules is dynamically enabled while the software product is executing on a computer.

9. The method of claim 1, wherein the configuration instructions facilitate ‘a la carte’ selection of the purchased software features by the user from modules which are already tested and compiled in the software product.

10. The method of claim 1, wherein the first location is a physical retail establishment.

11. The method of claim 1, wherein the first location is an online retail establishment.

12. The method of claim 1, wherein the first location is different from the second location.

13. The method of claim 1, wherein the configuration instructions are provided by a server to the second location via a network.

14. The method of claim 1, wherein the operations of receiving the access request and providing the configuration instructions are repeated after a time interval, thereby allowing synchronization of current software features that are enabled in the software product.

15. The method of claim 1, further comprising:
receiving a purchase request and payment from the user, wherein the purchase request includes information associated with additionally purchased software features, wherein the additionally purchased software features are associated with a second subset of modules in the software product; and
providing additional configuration instructions to the second location, wherein the additional configuration instructions dynamically enable the second subset of the modules.

16. The method of claim 15, wherein the additionally purchased features are different than the purchased features.

17. The method of claim 15, wherein the additionally purchased features at least partially overlap the purchased features.

18. The method of claim 15, wherein the payment is based on the additionally purchased software features.

19. A computer program product for use in conjunction with a computer system, the computer program product comprising a computer-readable storage medium and a computer-program mechanism embedded therein for providing access to at least a portion of a software product, the computer-program mechanism including:
instructions for receiving purchase information from a first location, wherein the purchase information includes information about purchased software features to which a user purchased access, and wherein the purchased software features are associated with a first subset of modules in the software product;
instructions for receiving an access request from a second location from which the software product can be accessed, wherein the access request includes an identifier provided to the user when the user purchased access to the purchased software features; and
instructions for providing configuration instructions to the second location, wherein the configuration instructions dynamically enable the first subset of the modules.

20. A computer system to provide access to at least a portion of a software product, comprising:
a processor;
memory;
a program module, wherein the program module is stored in the memory and configurable to be executed by the processor, the program module including:
instructions for receiving purchase information from a first location, wherein the purchase information includes information about purchased software features to which a user purchased access, and wherein the purchased software features are associated with a first subset of modules in the software product;
instructions for receiving an access request from a second location from which the software product can be accessed, wherein the access request includes an identifier provided to the user when the user purchased access to the purchased software features; and
instructions for providing configuration instructions to the second location, wherein the configuration instructions dynamically enable the first subset of the modules.
